(19) United States
(12) Patent Application Publication
(10) Pub. No.: US 2006/0023142 A1
(43) Pub. Date: Feb. 2, 2006

(54) Liquid crystal display panel

(75) Inventor: Ruey-Shii Chen, Kaohsiung City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Arima Display Corp., Taipei (TW)

(21) Appl. No.: 10/900,525

(22) Filed: Jul. 28, 2004

(51) Int. Cl. G02F 1/1335

(52) U.S. Cl. 349/96

(57) ABSTRACT

A liquid crystal display panel is provided. The liquid crystal display panel includes a first polarized substrate having a first surface and a second surface, a first alignment film mounted on the first surface, a first transparent electrode mounted between the first surface and the first alignment film, a second polarized substrate having a third surface and a fourth surface, a second alignment film mounted on the third surface, a second transparent electrode mounted between the third surface and the second alignment film and a liquid crystal layer, wherein the first polarized substrate and the second polarized substrate are so positioned that the first surface is near the third surface than the second surface, and the liquid crystal layer is placed therebetween.

### FIELD OF THE INVENTION

The present invention relates to a liquid crystal display panel, and more particularly to a polarizer of a liquid crystal display panel.

### BACKGROUND OF THE INVENTION

The active thin film transistor (TFT) is the control elements for actively controlling the light flux of each individual pixel. The principle of the image generation is that the desired color is generated by each individual pixel on the panel. To achieve this purpose, a back light is used which is normally formed by a number of fluorescent lamps. In order to light a single pixel, the panel should be divided into a number of ‘shutters’ or ‘doors’ to let the light pass through. The liquid crystal display (LCD) stands for displays that are based on liquid crystals. The molecular structures of the liquid crystal could be changed and therefore varying levels of light are able to pass through them (or the light could be blocked completely). How much light is allowed to pass and which colors are created are determined exactly by two polarizers, color filters and two alignment layers included in the LCD. All the layers are positioned between two glass substrates. A specific voltage is applied to the alignment film for creating an electric field which aligns the liquid crystals. Each pixel on the screen is composed of three subpixels, one for red, green and blue, which is similar to that in the cathode ray tube devices.

By applying a specific voltage across the glass substrates of the LCD panel, the liquid crystals are stood on end or twisted to become shutters for controlling the transmission of the light, and the image effects of bright/dark frames are created accordingly. Regarding the color LCD, the colors are formed by the light after further being passed through the color filters. Since the light is typically multi-oriented (unpolarized light), the polarizer is used to filter the non-specific oriented light and turn the remaining light into the specific oriented light (polarized light). In a word, the polarizer is used to turn the light passing through the liquid crystals into the polarized light. The development of the polarizer technology is helpful to improve the utility rate of the light, lower the power consumption of the LCD, and finally would be conformed to the requirements of the high luminance, low power consumption and high precision of the LCD panel.

Please refer to FIG. 1, which is a diagram showing the structure of the LCD panel according to the prior art. The LCD panel includes the first transparent substrate 11, the second transparent substrate 12, the liquid crystal layer 13, the first retardation film 14 and the second retardation film 15. The liquid crystal layer 13 is placed between the first transparent substrate 11 and the second transparent substrate 12. The first retardation film 14 is mounted on the outside of the first transparent substrate 11 and the second retardation film 15 is mounted on the outside of the second transparent substrate 12. The LCD panel further includes the first polarizer 16 and the second polarizer 17. The first polarizer 16 is mounted on the outside of the retardation film 14 and the second polarizer 17 is mounted on the outside of the retardation film 15. The LCD panel further includes the first alignment film 18 and the second alignment film 19. The first alignment film 18 is mounted on the inside of the first transparent substrate 11 and the second alignment film 19 is mounted on the inside of the second transparent substrate 12. The first transparent substrate 11 and the second transparent substrate 12 are typically made of the glass substrates or plastic substrates without extensibility. The first polarizer 16 and the second polarizer 17 are typically made by respectively mounting a triacetyl-cellulose (TAC) film on both side of a polyvinyl alcohol (PVA) film. The first and the second retardation films 14, 15 are used for improving the view angle of the LCD panel.

The key materials of the polarizer are PVA and TAC. PVA is a general plastic material which looks like the transparent plastic sheet. Owing to the light passes through the polarizer first and then the liquid crystal layer, the defects of the polarizer will be magnified. Therefore, the surfaces of the polarizer have to be smooth and delicate, and the polarizer should be capable of being used for a long time in the environment with the high temperature and the high humidity. Besides, since the polarizer is mounted on the upper and lower surfaces of the panel, the defects would be easily recognized by eyes if there exist some flaws in the mounting process. That could be resulted in the problem of the low yield rate of the LCD. Moreover, it is a tendency that the LCD would be thinner and moe flexible. Therefoer, the typical glass substrate could not conform to the requirements of the consumers in the respects of the thickness, the weight and the modeling.

Hence, it is known that a liquid crystal display panel having plastic substrates with an effect of the polarizer for overcoming the drawbacks in the prior art is needed.

### SUMMARY OF THE INVENTION

It is an object of the present invention to provide a liquid crystal display panel. The polarized substrate of the liquid crystal display panel of the present invention is not only provided with the function as the polarizer, but also is provided for lowering the thickness, the weight, the cost of the panel and improving the problem of the low yield rate generated in the mounting process of the polarizer. Because of lowering the thickness of the panel, which results in the shorter transmisson distance and the less loss of the light, the image quality of the LCD would be improved.

In accordance with one aspect of the present invention, a liquid crystal display panel is provided. The liquid crystal display panel includes a first polarized substrate having a first surface and a second surface, a first alignment film mounted on the first surface, a first transparent electrode mounted between the first surface and the first alignment film, a second polarized substrate having a third surface and a fourth surface, a second alignment film mounted on the third surface, a second transparent electrode mounted between the third surface and the second alignment film, and a liquid crystal layer, wherein the first polarized substrate and the second polarized substrate are so positioned that the first surface is near the third surface than the second surface, and the liquid crystal layer is placed therebetween.

Preferably, the first and the second polarized substrates are flexible plastic substrates with an effect of a polarizer.

Preferably, the first transparent electrode is a transparent electric conducting thin film.

Preferably, the transparent electric conducting thin film is made of a metal oxide.

Preferably, the second transparent electrode is a transparent electric conducting thin film.

Preferably, the transparent electric conducting thin film is made of a metal oxide.

Preferably, the liquid crystal display panel further includes a color filter mounted between the first polarized substrate and the liquid crystal layer.

Preferably, the liquid crystal display panel further includes a thin-film transistor layer mounted between the third surface of the second polarized substrate and the liquid crystal layer.

Preferably, the liquid crystal display panel further includes a first wide-viewing film mounted on the second surface of the first polarized substrate.

Preferably, the liquid crystal display panel further includes a second wide-viewing film mounted on the fourth surface of the second polarized substrate.

Preferably, the first and the second alignment films are made of polyimide.

Preferably, the first and the second polarized substrates are made by mounting a TAC film on both sides of a PVA extended substrate.

In accordance with another aspect of the present invention, another liquid crystal display panel is provided. The liquid crystal display panel includes a first polarized substrate having a first surface and a second surface, a second polarized substrate having a third surface and a fourth surface, and a liquid crystal layer, wherein the first polarized substrate and the second polarized substrate are so positioned that the first surface is near the third surface than the second surface, and the liquid crystal layer is placed therebetween.

Preferably, the liquid crystal display panel further includes a first alignment film mounted on the first surface.

Preferably, the liquid crystal display panel further includes a second alignment film mounted on the third surface.

Preferably, the liquid crystal display panel further includes a first wide-viewing film mounted on the second surface.

Preferably, the liquid crystal display panel further includes a second wide-viewing film mounted on the fourth surface.

The foregoing and other features and advantages of the present invention will be more clearly understood through the following descriptions with reference to the drawings, wherein:

### BRIEF DESCRIPTION OF THE DRAWING

FIG. 1 is a diagram showing the structure of the LCD panel according to the prior art.

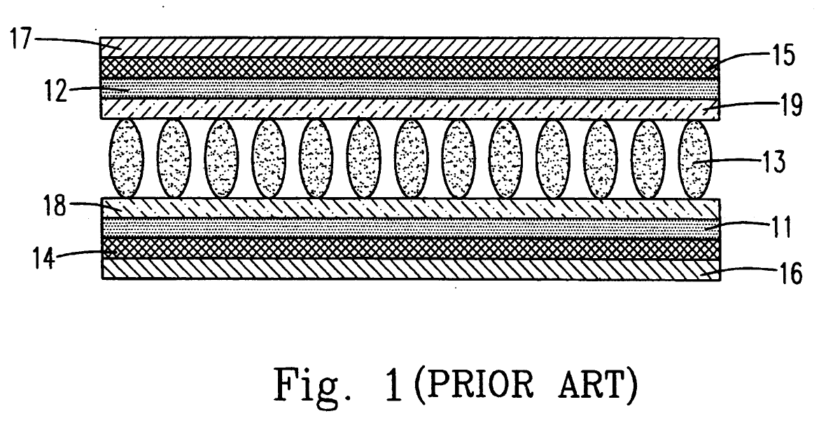

FIG. 2 is a diagram showing the structure of the LCD panel according to a preferred embodiment of the present invention; and

FIG. 3 is a diagram showing the structure of the LCD panel according to a further preferred embodiment of the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

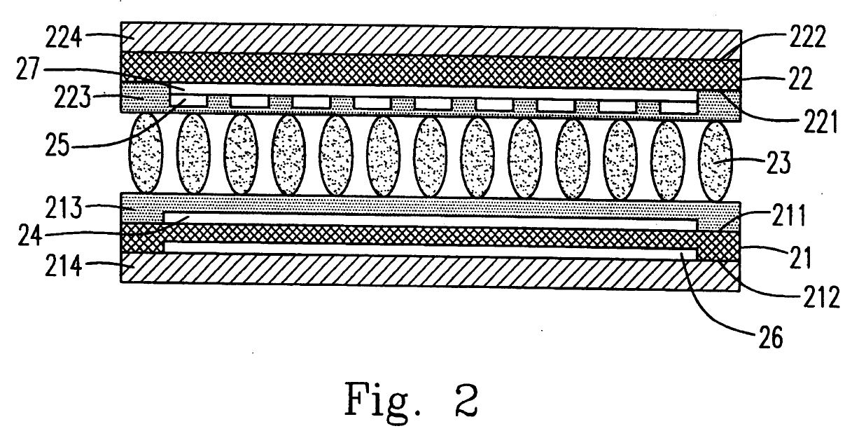

Please refer to FIG. 2, which is a diagram showing the structure of the LCD panel according to a preferred embodiment of the present invention. The liquid crystal display panel includes the first polarized substrate 21, the first alignment film 213, the first transparent electrode 24, the second polarized substrate 22, the second alignment film 223, the second transparent electrode 25 and the liquid crystal layer 23. The first polarized substrate 21 has a first surface 211 and a second surface 212 and the second polarized substrate 22 has a third surface 221 and a fourth surface 222. The first and second alignment films 213 and 223 are mounted on the first and second surfaces 211 and 221, respectively. The first transparent electrode 24 is mounted between the first surface 211 and the first alignment film 213 and the second transparent electrode 25 is mounted between the third surface 221 and the second alignment film 223. The first polarized substrate 21 and second polarized substrate 22 are so positioned that the first surface 211 is near the third surface 221 than the second surface 212, and the liquid crystal layer 23 is placed therebetween. The first and second polarized substrates 21, 22 are flexible plastic substrates with an effect of a polarizer. The first transparent electrode 24 is a transparent electric conducting thin film made of the metal oxides. Also, the second transparent electrode 25 is a transparent electric conducting thin film made of the metal oxides. In other words, the polarized substrate according to the present invention is equal to the substrate with the polarizer according to the prior art in functions. In addition, since the polarized substrate is made of the flexible material, it is able to be applied to many other applications. Therefore, the glass substrate or the plastic substrate with the polarizer in the prior art could be completely replaced by the polarized substrate according to the present invention.

Practically, the liquid crystal display panel further includes the first and second wide-viewing films 214, 224. The first and second wide-viewing films 214, 224 are mounted on the second surface 212 of the first polarized substrate 21 and the fourth surface 222 of the second polarized substrate 22, respectively. The liquid crystal display panel further includes the color filter 26 which is mounted between the first polarized substrate 21 and the liquid crystal layer 23. When the liquid crystal display panel is applied to the TFT-LCD, the liquid crystal display panel further includes the thin-film transistor layer 27 which is mounted between the third surface 221 of the second polarized substrate 22 and liquid crystal layer 23 for controlling the motion of the liquid crystals. Moreover, the first and second alignment films 213, 223 made of polyimide resins are used for aligning the liquid crystals before the electric field is applied. For example, the rows of grooves printed by roller printing method are used to arrange the liquid crystals in the grooves in the same direction. The first polarized substrate 21 and the second polarized substrate 22 are made by mounting a TAC film on both sides of a PVA extended substrate. The polarized substrate is the substrate that only permits some specific oriented light passing through it. For example, practically, the first and second polarized substrates 21, 22 are driven by the electric field for displaying the characters and the patterns. The first and second wide-viewing films 214, 224 are used for enhancing the viewing angle of the LCD to 100°˜140°.

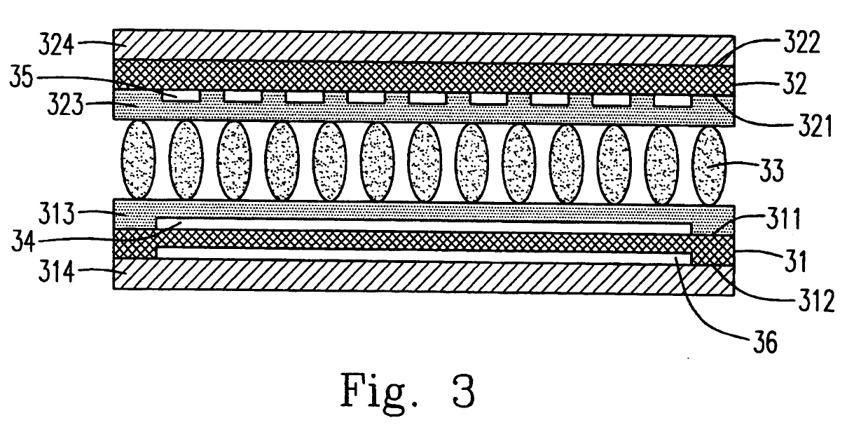

Please refer to FIG. 3, which is a diagram showing the structure of the LCD panel according to a further preferred embodiment of the present invention. The liquid crystal display panel includes the first polarized substrate 31, the second polarized substrate 32 and the liquid crystal layer 33. The first polarized substrate 31 has a first surface 311 and a second surface 312, and the second polarized substrate 32 has a third surface 321 and a fourth surface 322. The first polarized substrate 31 and the second polarized substrate 32 are so positioned that the first surface 311 is near the third surface 321 than the second surface 312, and the liquid crystal layer 33 is placed therebetween. Certainly, one of the features of the present invention is to use the polarized substrate for replacing the glass substrate or the plastic substrate according to the prior art. The polarized substrates 31, 32 are both flexible plastic substrates with an effect of a polarizer. In other words, the basic structure of the LCD according to the present invention includes the polarized substrates 31, 32 and the liquid crystal layer 33 therebetween. Therefore, it is possible to replace the conventional LCD completely with the liquid crystal display panel having the polarized substrates which are made of flexible plastic materials according to the present invention.

Practically, the liquid crystal display panel further includes the first and second transparent electrodes 34, 35. The first transparent electrode 34 is mounted between the first surface 311 and the first alignment film 313. The second transparent electrode 35 is mounted between the third surface 321 and the second alignment film 323. The first transparent electrode 34 is a transparent electric conducting thin film made of the metal oxides. Also, the second transparent electrode 35 is a transparent electric conducting thin film made of the metal oxides. The liquid crystal display panel further includes the color filter 36 which is mounted between the first polarized substrate 31 and the liquid crystal layer 33. Moreover, the first and second alignment films 313, 323 made of polyimide resins are used for aligning the liquid crystals before the electric field is applied thereto. For example, the rows of grooves printed by roller printing method are used to arrange the liquid crystals in the grooves in the same direction. The liquid crystal display panel further includes the first wide-viewing film 314 mounted on the second surface 312 and the second wide-viewing film 324 mounted on the fourth surface 322. The first and second wide-viewing films 314, 324 are used for enhancing the viewing angle of the LCD to 100°˜140°. Besides, the first polarized substrate 31 and the second polarized substrate 32 are made by mounting a TAC film on both sides of a PVA extended substrate. The polarized substrate is the substrate that only permits some specific oriented light passing through it. For example, practically, the first and second polarized substrates 31, 32, which are placed interlacedly, are driven by the electric field for displaying the characters and the patterns. Since the thickness of the LCD having the liquid crystal display panel of the present invention is lower than that of the LCD according to the prior art, the transmission distance is shorter and the loss of the light is less. Therefore, the image quality displayed on the LCD is better than that of the LCD having the glass substrate or the plastic substrate with the polarizer according to the prior art.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claim is:

1. A liquid crystal display panel, comprising:
a first polarized substrate having a first surface and a second surface;
a first alignment film mounted on said first surface;
a first transparent electrode mounted between said first surface and said first alignment film;
a second polarized substrate having a third surface and a fourth surface;
a second alignment film mounted on said third surface;
a second transparent electrode mounted between said third surface and said second alignment film; and
a liquid crystal layer,
wherein said first polarized substrate and said second polarized substrate are so positioned that said first surface is near said third surface than said second surface, and said liquid crystal layer is placed therebetween.

2. The liquid crystal display panel according to claim 1 wherein said first and said second polarized substrates are flexible plastic substrates with an effect of a polarizer.

3. The liquid crystal display panel according to claim 1 wherein said first transparent electrode is a transparent electric conducting thin film.

4. The liquid crystal display panel according to claim 3 wherein said transparent electric conducting thin film is made of a metal oxide.

5. The liquid crystal display panel according to claim 1 wherein said second transparent electrode is a transparent electric conducting thin film.

6. The liquid crystal display panel according to claim 5 wherein said transparent electric conducting thin film is made of a metal oxide.

7. The liquid crystal display panel according to claim 1 further comprising a color filter mounted between said first polarized substrate and said liquid crystal layer.

8. The liquid crystal display panel according to claim 1 further comprising a thin-film transistor layer mounted between said third surface of said second polarized substrate and said liquid crystal layer.

9. The liquid crystal display panel according to claim 1 further comprising a first wide-viewing film mounted on said second surface of said first polarized substrate.

10. The liquid crystal display panel according to claim 1 further comprising a second wide-viewing film mounted on said fourth surface of said second polarized substrate.

11. The liquid crystal display panel according to claim 1 wherein said first and said second alignment films are made of polyimide.

12. The liquid crystal display panel according to claim 1 wherein said first and said second polarized substrates are made by mounting a TAC film on both sides of a PVA extended substrate.

13. A liquid crystal display panel, comprising:
a first polarized substrate having a first surface and a second surface;
a second polarized substrate having a third surface and a fourth surface; and
a liquid crystal layer,
wherein said first polarized substrate and said second polarized substrate are so positioned that said first surface is near said third surface than said second surface, and said liquid crystal layer is placed therebetween.

14. The liquid crystal display panel according to claim 13 further comprising a first alignment film mounted on said first surface.

15. The liquid crystal display panel according to claim 13 further comprising a second alignment film mounted on said third surface.

16. The liquid crystal display panel according to claim 13 further comprising a first wide-viewing film mounted on said second surface.

17. The liquid crystal display panel according to claim 13 further comprising a second wide-viewing film mounted on said fourth surface.
